(19) United States
(12) Patent Application Publication
(10) Pub. No.: US 2006/0087047 A1
(43) Pub. Date: Apr. 27, 2006

(54) Fluid mixing apparatus

(76) Inventors: Ashok Narain Mathur, Allentown, PA (US); David Lester Rarig, Emmaus, PA (US)

Correspondence Address: AIR PRODUCTS AND CHEMICALS, INC.;PATENT DEPARTMENT, 7201 HAMILTON BOULEVARD, ALLENTOWN, PA, 181951501, US

(21) Appl. No.: 11/257,233

(22) Filed: Oct. 24, 2005

Related U.S. Application Data
(60) Provisional application No. 60/621,256, filed on Oct. 22, 2004.

(51) Int. Cl. B01F 3/04

(52) U.S. Cl. 261/93

(57) ABSTRACT

A propeller type fluid mixing apparatus for inducing the flow of a fluid into a liquid being treated by the rotation of a propeller in the liquid comprising a drive shaft supported for rotary motion about its axis having first and second ends; motor connected to a first end of said drive shaft for rotating said drive shaft; a propeller attached to a second end of said drive shaft whereby the rotation of said drive shaft rotates said propeller and induces a flow of the liquid in which the propeller is disposed; at least one conduit attached to said housing, said conduit having an inlet portion and an outlet portion; said outlet portion comprises a diffuser ring said diffuser ring being located a distance upstream of said propeller that is no more than 2 times the outside diameter of the propeller and the effective diameter of the diffuser ring is equal to or less than the outside diameter of the propeller; and said inlet portion of said conduit attached to a pressurized source for said fluid.

### CROSS-REFERENCE TO RELATED APPLICATIONS

This application claims priority to provisional patent application U.S. Ser. No.

60/621,256, entitled “Gas Mixer for Fluids”, having the same inventors and filed Oct. 22, 2005, incorporated herein by reference.

### BACKGROUND OF THE INVENTION

The present invention relates broadly to an apparatus for mixing a gas, e.g. air or enriched air with a liquid. More particularly, the present invention relates to an apparatus for aerating a liquid, such as water in an aquaculture or wastewater treatment application, or for any applications in which a gas needs to be mixed into a liquid.

Aeration apparatus are used in the treatment of water for the purpose of increasing the dissolved oxygen (DO) content of the water. A certain amount of dissolved oxygen is required for the life of fish and other aquatic organisms. Dissolved oxygen is also required to prevent the formation of offensive odors and to break down organic matter in water. The biochemical oxygen demand (BOD) is the measure of the amount of oxygen consumed in the biological processes which break down organic matter in water. A high BOD indicates that large amounts of organic waste are present and will use up large amounts of dissolved oxygen. Aeration apparatus are especially useful in increasing the amount of dissolved oxygen, and hence is useful in high-BOD situations.

Aerators utilized in waste water treatment can be broadly classified into two types, a diffused air type, and a mechanical type. A diffused air type aerator introduces air or pure oxygen into the water via submerged porous diffusers or nozzles. Mechanical type aerators agitate the water so as to promote solution of air from the atmosphere.

Mechanical type aerators are further classified as either surface aerators or turbine aerators. A surface aerator utilizes a submerged or partially submerged propeller which agitates the water vigorously to thereby entrain air in the water and cause a rapid change in the air-water interface. Turbine or propeller aerators generally utilize a rotating impeller or propeller which is disposed a certain distance below the surface of the water being treated. A draft tube is supported generally coaxial with the axis of rotation of the propeller, and is utilized to supply air to the liquid adjacent the propeller.

### BRIEF SUMMARY OF THE INVENTION

This invention provides a propeller type fluid mixing apparatus for inducing the flow of a fluid into a liquid being treated by the rotation of a propeller in the liquid comprising: a housing and at least partially therein a drive shaft supported for rotary motion about its axis having first and second ends; motor means connected to a first end of said drive shaft for rotating said drive shaft; a propeller attached to a second end of said drive shaft whereby the rotation of said drive shaft rotates said propeller and induces a flow of the liquid in which the propeller is disposed; at least one conduit attached to said housing, said conduit having an inlet portion and an outlet portion; said outlet portion comprises a diffuser ring with said diffuser ring being located a distance upstream of said propeller that is no more than 2 times the outside diameter of the propeller and the effective diameter of the diffuser ring is less than or equal to the outside diameter of the propeller; and said inlet portion of said conduit is attached to a pressurized source for said fluid.

The present invention is directed to a propeller type fluid mixing apparatus for inducing the flow of a fluid, for example, a gas, e.g. air or enriched air, for example with oxygen or ozone into a liquid being treated by the rotation of a propeller in the liquid. The enriched air can be oxygen or ozone enriched air.

The apparatus includes a housing. As shown, the drive shaft is supported for rotary motion about its axis within the interior of the housing. A motor is connected to a first end of the drive shaft for rotating the drive shaft. A propeller is attached to a second end of the drive shaft whereby the rotation of the drive shaft rotates the propeller and induces a flow of the liquid in which the propeller is disposed. The conduit may be supported by attachment to the housing or other supports.

The diffuser ring may be made wholly or partly of a porous material or has one or more holes to distribute said fluid into said liquid. The diffuser ring is supplied with pressurized fluid in fluid communication with the conduit. The holes may be located anywhere on the ring including as shown, on the outside periphery of the diffuser ring away from the drive shaft. The pressurized fluid source may be an oxygen enriched air stream (such as a gas that comprises more than 30% by volume oxygen) produced by a vacuum swing absorber device, a pressure swing absorber device or from a tank that stores the oxygen enriched gas.

The diffuser ring is located upstream of the propeller and has an effective diameter that is less than the outside diameter of the propeller. By configuring the diffuser ring in accordance with this invention, the fluid will exit the diffuser ring and be directed toward the propeller by the flow of the liquid towards the propeller caused by the movement of the propeller. By directing the fluid toward the propeller upstream of the propeller, as opposed to at the periphery of the propeller or downstream of the propeller, the propeller will entrain the fluid further downstream of the propeller, and away from the surface of the liquid on which the apparatus is located. When fluid is injected at the periphery of the propeller, or downstream of the propeller, the fluid tends to be dispersed to the sides of the propeller and not downstream of the propeller, which for gaseous fluids will result in their rising to the surface of the liquid, and diffusion to the air above the liquid. Additionally, directing the fluid into the propeller helps to break up the fluid causing better diffusion and dissolution into the liquid.

Various advantages and features of novelty which characterize our invention are pointed out with particularity in the claims annexed hereto and forming a part hereof. However, for a better understanding of the invention, its advantages, and objects attained by its use, reference should be had to the drawing which forms a further part hereof, and to the accompanying descriptive matter, in which there is illustrated and described a preferred embodiment of the invention.

### BRIEF DESCRIPTION OF SEVERAL VIEWS OF THE DRAWINGS

FIG. 1 is a perspective view of a first embodiment of the apparatus of this invention.

FIG. 2 is a perspective view of a second embodiment of the apparatus of this invention.

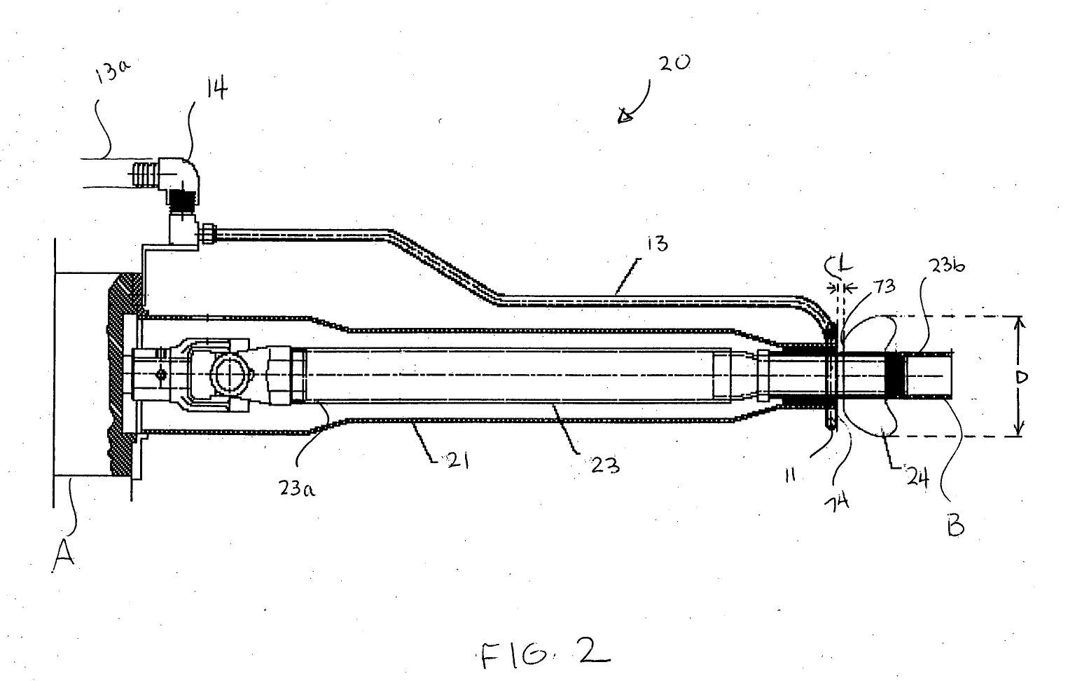

FIG. 3 is a bottom view of one embodiment of the diffuser ring useful in the apparatus of this invention.

FIG. 4 is a bottom view of a second embodiment of the diffuser ring useful in the apparatus of this invention.

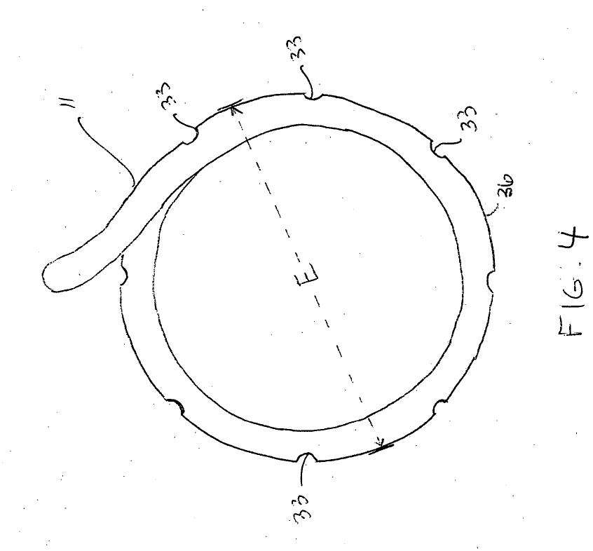

### DETAILED DESCRIPTION OF THE INVENTION

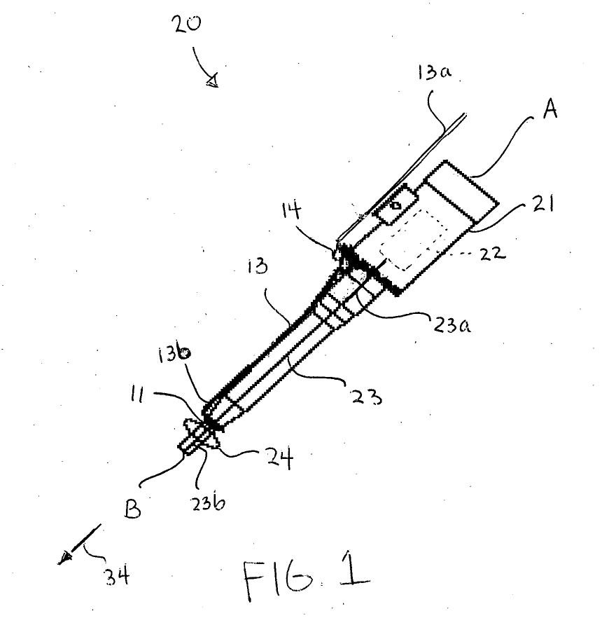

The drawing shows a fluid mixing apparatus 20 of this invention. The top of the apparatus, labeled A in FIG. 1 is located outside or above the surface of the liquid to be injected with fluid, and is located upstream of the direction that the propeller pushes the water when driven by the motor 22. The propeller pushes the liquid and fluid downstream in the direction shown by the arrow 34. The bottom of the apparatus, labeled B in FIG. 1 is located submerged below the surface of the liquid to be injected with fluid. The liquid is not shown; however, the use of aeration apparatus or propeller mixing devices is known. Details which are missing herein about such apparatus can be found in the prior art, for example, U.S. Pat. Nos. 4,741,825; 4,240,990; 4,308,221; 4,774,031 and 4,954,295, incorporated in their entirities by reference herein.

The fluid mixing apparatus 20 comprises a housing 21, motor 22, drive shaft 23, propeller 24, fluid supply conduit 13, comprising diffuser ring 11. The drive shaft has first end 23a and second end 23b. The first end 23a is connected to the motor 22 and the second end 23b is connected to the propeller 24. The diffuser ring may be contiguous with the conduit as shown in the figures or it may comprise a separate part that is attached in fluid communication with the conduit. The diffuser ring may be made wholly or partly of a porous material. Alternatively, it may be made of a nonporous material having one or more holes 12 therethrough to distribute the fluid into the liquid. The diffuser ring 11 is supplied with pressurized fluid via conduit 13 which has inlet 13a in fluid commucation with a fluid source (not shown), and outlet 13b in fluid communication with the diffuser ring 11. Additionally, as shown the conduit comprises a pipe fitting connection 14 connecting the inlet 13a and outlet 13b portions of the conduit.

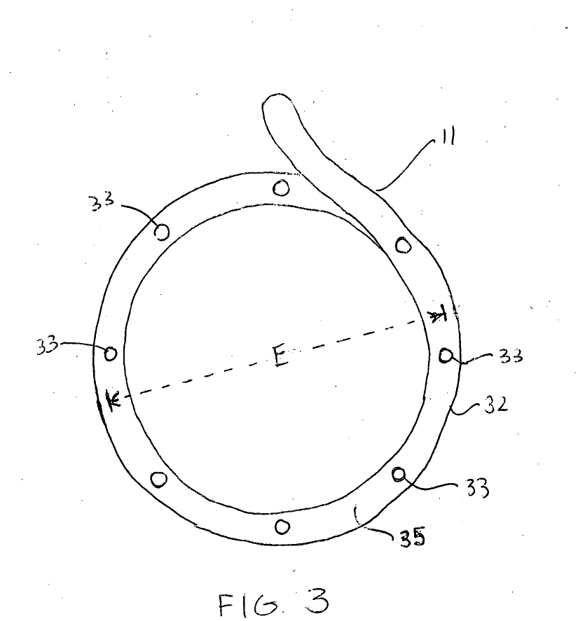

The diffuser ring 11 comprises holes 33 that may be located anywhere on the outside surface 32 of the diffuser ring 11. In the embodiments shown the holes are located on the periphery of the diffuser ring, specifically on the bottom surface 35 of the diffuser ring as shown in FIG. 3 or on the outside surface 36 of the ring. The outside surface is located on the periphery of the ring away from the drive shaft. In alternative embodiments the holes can be located any where on the diffuser ring, for example the inside surface of the diffuser ring, or all over the surface of the diffuser ring.

The propeller can have any shape. Presently preferred is a marine propeller having two to five blades, preferably three, designed for maximum propulsion of water for a given power input. The propeller typically rotates between 1700 and 3600 rpm. The propeller is directly driven by the motor, preferably an electric motor.

The drive shaft 23 may be open, closed or plugged. For best results for entraining the fluid injected via the diffuser ring, the drive shaft should be closed or plugged.

The effective diameter E of the diffuser ring 11 is preferably equal to or less than the outside diameter D of the propeller 24. The effective diameter E is typically within the range between from 0.1 to 1 times or 0.4 to 0.9 times that of the propeller outside diameter D. The diffuser ring, although called a diffuser ring, may take any shape, such as circular, elliptical, rectangular, square, etc. therefore for some shapes the diffuser ring will not have a diameter. For non-spherical shapes the effective diameter of the diffuser ring is calculated by calculating the area enclosed by the holes on the diffuser ring by connecting the outermost point of the holes by lines, and dividing by π.

If the diffuser ring is designed with one or more holes, the number of holes and the size of the holes may vary based upon the amount of fluid to be mixed into the liquid. It is generally preferred to have a large number of small holes for more efficient mixing; however, smaller holes are more likely to be plugged by the solids in the fluid or the liquid. Therefore, the size and number of holes should be designed for the specific application. Presently for aquaculture application, the diffuser ring should have between from 4 to 64, or between 4 to 32 holes of between from 1/16 inch to ⅜ inch in diameter or effective diameter.

The diffuser ring is located upstream of the propeller. The downstream surface 74 of the diffuser ring 11 should be located a distance L that is no more than 2 times the outside diameter D of the propeller away from the upstream surface 73 of the propeller 24. In alternative embodiments the diffuser ring is located a distance L that is no more than 1.5 times or 1 time the outside diameter D of the propeller away from the upstream surface 73 of the propeller 24. In alternative embodiments the diffuser ring is located a distance L that is no more than 0.5 times the outside diameter D of the propeller away from the upstream surface 73 of the propeller 24.

The fluid mixing apparatus shown can be used for aquaculture or wastewater treatment applications, for examples, or for any applications in which a fluid needs to be mixed into a fluid.

The size and materials of construction of the fluid mixing apparatus are designed to meet the requirements for the mixing of the fluid in the liquid for an application. The sizes of the elements of the fluid mixing apparatus can be adjusted or multiple fluid mixing apparatus can be used in an application. Material of construction of the conduit and diffuser ring is stainless steel or other such materials, metallic or non-metallic that resist corrosion in seawater conditions, for example. Additionally, presently it is preferred to use a stainless steel or a coated motor for aquaculture applications.

In operation the fluid mixing apparatus is mounted on a support not shown, with motor and the upper ends of conduits above the surface of a body of liquid to be aerated, oxygenated, mixed, and/or injected with the fluid. When the motor is energized a flow of the liquid results from operation of propeller, the flow having a direction generally aligned with the axis of the fluid mixing device. Movement of the liquid past diffuser ring entrains and dissolves the fluid, e.g. oxygen enriched gas into the liquid, assisted by the positive pressure at which the fluid is supplied. Pressure of the fluid has the advantage of greater gas dissolution efficiency.

An improved fluid mixing apparatus in accordance with the present invention results in a more effective use of the liquid flow provided by a propeller, by enabling entrainment of the fluid, e.g. oxygen rich gas at the center of the flow, so that a majority if not substantially all of the fluid is pushed in the direction of arrow 34; thereby, providing an increased time for fluid-liquid contact to maximize diffusion of the fluid into the liquid below the surface. The present invention may also result in reduced power consumption to drive the propeller due to two-phase fluid introduced upstream of the propeller.

Numerous characteristics and advantages of this invention have been set forth in the foregoing description, together with details of the structure and function of the invention, and the novel features thereof are pointed out in the appended claims. The disclosure, however, is illustrative only, and changes may be made in detail, especially in matters of shape, size, and arrangement of parts, within the principle of the invention, to the full extent indicated by the broad general meaning of the terms in which the appended claims are expressed.

1. A propeller type fluid mixing apparatus for inducing the flow of a fluid into a liquid being treated by the rotation of a propeller in the liquid comprising:
a drive shaft supported for rotary motion about its axis having first and second ends;
motor means connected to a first end of said drive shaft for rotating said drive shaft;
a propeller attached to a second end of said drive shaft whereby the rotation of said drive shaft rotates said propeller and induces a flow of the liquid in which the propeller is disposed;
at least one conduit attached to said housing, said conduit having an inlet portion and an outlet portion; said outlet portion comprises a diffuser ring said diffuser ring being located a distance upstream of said propeller that is no more than 2 times the outside diameter of the propeller and the effective diameter of the diffuser ring is no more than the outside diameter of the propeller; and
said inlet portion of said conduit is in fluid communication with a pressurized source for said fluid.

2. A propeller type fluid mixing apparatus in accordance with claim 1 wherein said diffuser ring comprises a porous material.

3. A propeller type fluid mixing apparatus in accordance with claim 1 wherein said diffuser ring comprises a plurality of holes about its periphery.

4. A propeller type fluid mixing apparatus in accordance with claim 1 wherein said diffuser ring comprises a plurality of holes located so that the fluid exiting those holes is directed downstream.

5. A propeller type fluid mixing apparatus in accordance with claim 1 wherein said diffuser ring comprises between 4 and 64 holes spaced around said diffuser ring.

6. A propeller type fluid mixing apparatus in accordance with claim 4 wherein said holes in said diffuser ring have a diameter between 1/16 and ⅜ inch.

7. A propeller type fluid mixing apparatus in accordance with claim 1 wherein said diffuser ring comprises a plurality of holes located in a plane that is perpendicular to said drive shaft.

8. A propeller type fluid mixing apparatus in accordance with claim 1 wherein portions of said conduit are secured to the outer surface of said outer housing.

9. A propeller type fluid mixing apparatus in accordance with claim 1 wherein the shaft is solid.

10. A propeller type fluid mixing apparatus in accordance with claim 1 wherein said fluid is oxygen enriched air.

11. A propeller type fluid mixing apparatus in accordance with claim 1 wherein said fluid is ozone enriched air.

12. A propeller type fluid mixing apparatus in accordance with claim 1 wherein said fluid is ozone enriched oxygen.
